(19) United States
(12) Patent Application Publication
(10) Pub. No.: US 2014/0378075 A1
(43) Pub. Date: Dec. 25, 2014

(54) MULTI-FREQUENCY RANGE PROCESSING FOR RF FRONT END

(71) Applicant: QUALCOMM Incorporated, San Diego, CA (US)

(72) Inventors: Sumit Verma, San Diego, CA (US); Liang Zhao, Sunnyvale, CA (US); Hector Cuevas, JR., San Diego, CA (US)

(73) Assignee: QUALCOMM Incorporated, San Diego, CA (US)

(21) Appl. No.: 14/050,980

(22) Filed: Oct. 10, 2013

Related U.S. Application Data
(60) Provisional application No. 61/837,505, filed on Jun. 20, 2013.

(51) Int. Cl. H04B 7/12

(52) U.S. Cl. CPC H04B 7/12
USPC 455/77

(57) ABSTRACT

Techniques for supporting multi-frequency range signal processing for a wireless device. In an aspect, a first antenna is provided to support first and third frequency ranges. A second antenna is separately provided to support two separate ranges that are each intermediate in frequency between the first and third frequency ranges. In an aspect, the two separate ranges may correspond to, e.g., a GPS range and a 1500-MHz band. To separate the two ranges of the second antenna, one or more low-pass and/or band-pass filters may be provided. In other aspects, a third antenna may be added to support a fourth frequency range higher than the third frequency range. Other frequency range combinations, dual antenna aspects, and carrier aggregation features are further disclosed herein.

### RELATED APPLICATIONS

This application claims the benefit of U.S. Provisional Patent Application No. 61/837,505, entitled “GPS Extractors for Carrier Aggregation,” filed Jun. 20, 2013, the contents of which are hereby incorporated by reference in their entirety.

### BACKGROUND

1. Field

The disclosure relates to multiple frequency range processing for radio-frequency (RF) circuits.

2. Background

State-of-the-art wireless devices are commonly designed to support radio processing for multiple frequency ranges. For example, to support a carrier aggregation (CA) feature for the Long-Term Evolution (LTE) standard, multiple carriers across multiple frequency ranges may be simultaneously received and processed by a wireless device. In this case, frequency selection and isolation techniques should be applied, to ensure that signals of one frequency range do not interfere with those of another.

Prior art techniques for accommodating carrier aggregation (CA) include, e.g., providing frequency separation elements such as diplexers or quadplexers to isolate the multiple frequency ranges from each other. However, for frequency ranges that are relatively close, it may be costly to design such frequency separation elements to isolate the signals with sufficiently high quality factor (Q). In certain implementations, a wireless device may further be required to support frequencies associated with a global positioning system (GPS).

It would thus be desirable to provide techniques for relaxing the constraints placed on wireless devices accommodating multiple frequency bands, including GPS, and further for accommodating the requirements of state-of-the-art wireless standards such as LTE.

### BRIEF DESCRIPTION OF THE DRAWINGS

FIG. 1 illustrates a block diagram of a design of a prior art wireless communication device in which the techniques of the present disclosure may be implemented.

FIG. 2 illustrates a frequency spectrum showing a generalized allocation of multiple radio frequency ranges.

FIG. 3 illustrates a prior art implementation of an RF front end in which two antennas are shared amongst circuitry for processing multiple frequency ranges.

FIG. 4 illustrates an exemplary embodiment of an RF front end for simultaneously processing multiple frequency ranges according to the present disclosure.

FIG. 5 illustrates an exemplary embodiment including a frequency separation block having an R2.1 section and an R2.2 section.

FIG. 6 illustrates an exemplary embodiment of an RF front end according to the present disclosure.

FIG. 7 illustrates an exemplary embodiment of range-specific circuitry, e.g., provided for R2.1.

FIG. 8 illustrates an exemplary embodiment wherein an antenna with associated range-specific circuitry is provided in a wireless device.

FIG. 9 illustrates an alternative exemplary embodiment of an RF front end accommodating three antennas according to the present disclosure.

FIG. 10 illustrates an exemplary embodiment of a wireless device implementing the techniques of the present disclosure.

FIG. 11 illustrates an exemplary embodiment of a method according to the present disclosure.

FIG. 12 illustrates an alternative exemplary embodiment wherein an antenna with associated range-specific circuitry is provided in a wireless device.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The detailed description set forth below in connection with the appended drawings is intended as a description of exemplary aspects of the invention and is not intended to represent the only exemplary aspects in which the invention can be practiced. The term “exemplary” used throughout this description means “serving as an example, instance, or illustration,” and should not necessarily be construed as preferred or advantageous over other exemplary aspects. The detailed description includes specific details for the purpose of providing a thorough understanding of the exemplary aspects of the invention. It will be apparent to those skilled in the art that the exemplary aspects of the invention may be practiced without these specific details. In some instances, well-known structures and devices are shown in block diagram form in order to avoid obscuring the novelty of the exemplary aspects presented herein. In this specification and in the claims, the terms “module” and “block” may be used interchangeably to denote an entity configured to perform the operations described. It will be appreciated that similarly numbered elements throughout the figures hereinbelow may generally correspond to elements performing the same functionality, and accordingly, the description of such repeated elements may be omitted in certain instances.

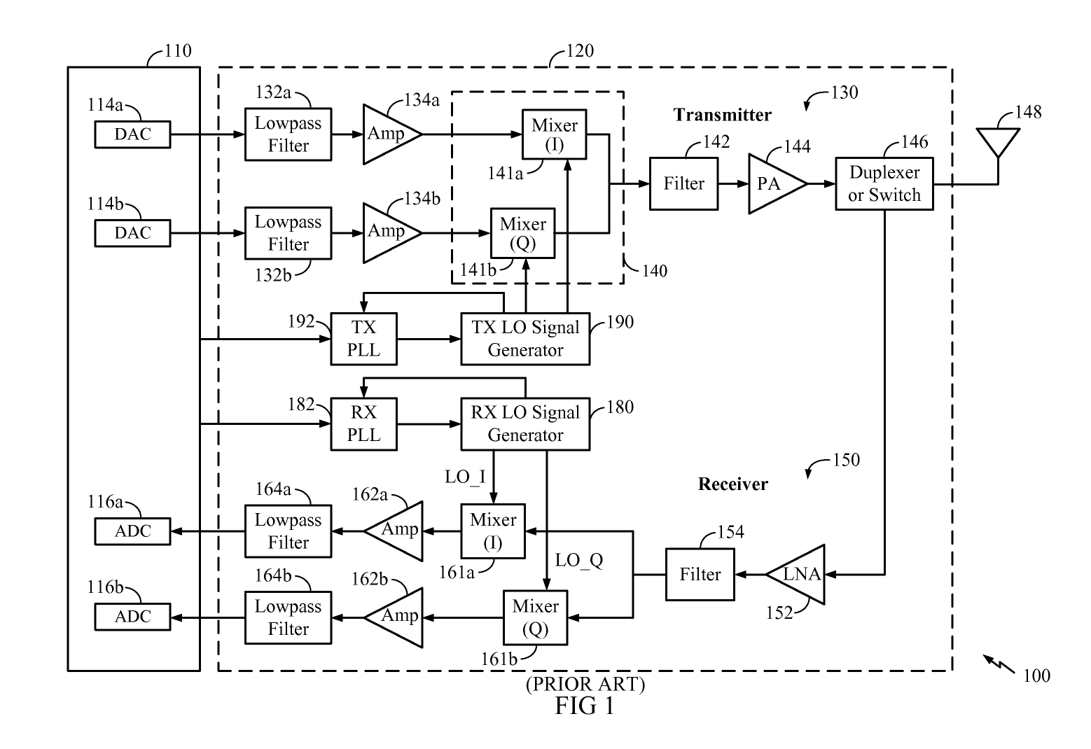

FIG. 1 illustrates a block diagram of a design of a prior art wireless communication device 100 in which the techniques of the present disclosure may be implemented. FIG. 1 shows an example transceiver design. In general, the conditioning of the signals in a transmitter and a receiver may be performed by one or more stages of amplifier, filter, upconverter, downconverter, etc. These circuit blocks may be arranged differently from the configuration shown in FIG. 1. Furthermore, other circuit blocks not shown in FIG. 1 may also be used to condition the signals in the transmitter and receiver. Unless otherwise noted, any signal in FIG. 1, or any other figure in the drawings, may be either single-ended or differential. Some circuit blocks in FIG. 1 may also be omitted.

In the design shown in FIG. 1, wireless device 100 includes a transceiver 120 and a data processor 110. The data processor 110 may include a memory (not shown) to store data and program codes. Transceiver 120 includes a transmitter 130 and a receiver 150 that support bi-directional communication. In general, wireless device 100 may include any number of transmitters and/or receivers for any number of communication systems and frequency bands. All or a portion of transceiver 120 may be implemented on one or more analog integrated circuits (ICs), RF ICs (RFICs), mixed-signal ICs, etc.

A transmitter or a receiver may be implemented with a super-heterodyne architecture or a direct-conversion architecture. In the super-heterodyne architecture, a signal is frequency-converted between radio frequency (RF) and baseband in multiple stages, e.g., from RF to an intermediate frequency (IF) in one stage, and then from IF to baseband in another stage for a receiver. In the direct-conversion architecture, a signal is frequency converted between RF and baseband in one stage. The super-heterodyne and direct-conversion architectures may use different circuit blocks and/or have different requirements. In the design shown in FIG. 1, transmitter 130 and receiver 150 are implemented with the direct-conversion architecture.

In the transmit path, data processor 110 processes data to be transmitted and provides I and Q analog output signals to transmitter 130. In the exemplary embodiment shown, the data processor 110 includes digital-to-analog-converters (DAC's) 114a and 114b for converting digital signals generated by the data processor 110 into the I and Q analog output signals, e.g., I and Q output currents, for further processing.

Within transmitter 130, lowpass filters 132a and 132b filter the I and Q analog output signals, respectively, to remove undesired images caused by the prior digital-to-analog conversion. Amplifiers (Amp) 134a and 134b amplify the signals from lowpass filters 132a and 132b, respectively, and provide I and Q baseband signals. An upconverter 140 upconverts the I and Q baseband signals with I and Q transmit (TX) local oscillator (LO) signals from a TX LO signal generator 190 and provides an upconverted signal. A filter 142 filters the upconverted signal to remove undesired images caused by the frequency upconversion as well as noise in a receive frequency band. A power amplifier (PA) 144 amplifies the signal from filter 142 to obtain the desired output power level and provides a transmit RF signal. The transmit RF signal is routed through a duplexer or switch 146 and transmitted via an antenna 148.

In the receive path, antenna 148 receives signals transmitted by base stations and provides a received RF signal, which is routed through duplexer or switch 146 and provided to a low noise amplifier (LNA) 152. The duplexer 146 is designed to operate with a specific RX-to-TX duplexer frequency separation, such that RX signals are isolated from TX signals. The received RF signal is amplified by LNA 152 and filtered by a filter 154 to obtain a desired RF input signal. Downconversion mixers 161a and 161b mix the output of filter 154 with I and Q receive (RX) LO signals (i.e., LO_I and LO_Q) from an RX LO signal generator 180 to generate I and Q baseband signals. The I and Q baseband signals are amplified by amplifiers 162a and 162b and further filtered by lowpass filters 164a and 164b to obtain I and Q analog input signals, which are provided to data processor 110. In the exemplary embodiment shown, the data processor 110 includes analog-to-digital-converters (ADC's) 116a and 116b for converting the analog input signals into digital signals to be further processed by the data processor 110.

In FIG. 1, TX LO signal generator 190 generates the I and Q TX LO signals used for frequency upconversion, while RX LO signal generator 180 generates the I and Q RX LO signals used for frequency downconversion. Each LO signal is a periodic signal with a particular fundamental frequency. A PLL 192 receives timing information from data processor 110 and generates a control signal used to adjust the frequency and/or phase of the TX LO signals from LO signal generator 190. Similarly, a PLL 182 receives timing information from data processor 110 and generates a control signal used to adjust the frequency and/or phase of the RX LO signals from LO signal generator 180.

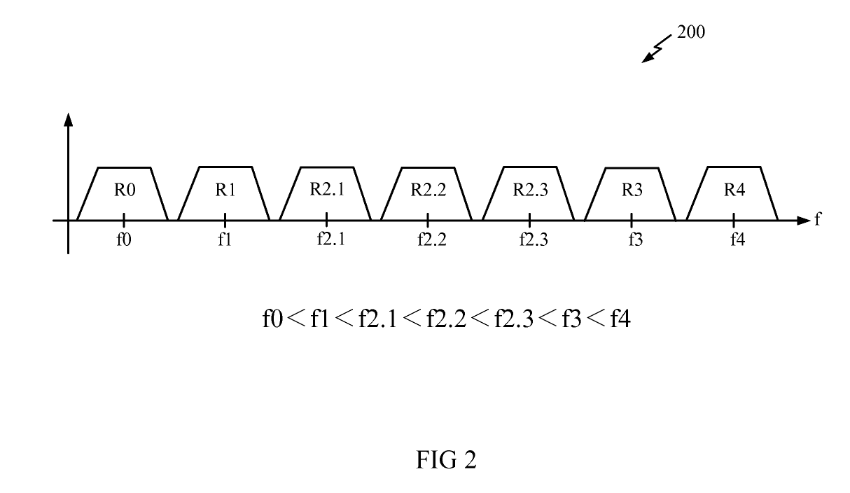

State-of-the-art wireless devices may support simultaneous processing of multiple radio frequency ranges, e.g., as may be required to implement a carrier aggregation (CA) feature of the Long-Term Evolution (LTE) wireless standard. FIG. 2 illustrates a frequency spectrum 200 showing a generalized allocation of multiple radio frequency ranges. Note FIG. 2 is shown for illustrative purposes only, and is not meant to limit the scope of the present disclosure to any particular frequency spectrum or allocation of frequency ranges or sub-ranges shown. For example, spectrum 200 is not meant to limit the scope of the present disclosure to any particular number of frequency ranges. It will be appreciated that particular exemplary embodiments of the present disclosure may accommodate fewer or greater than the number of frequency ranges illustratively shown.

In FIG. 2, spectrum 200 includes a plurality of frequency ranges R0, R1, R2.1, R2.2, R2.3, R3, and R4, with labeled frequencies f0, f1, f2.1, f2.2, f2.3, f3, and f4 corresponding to representative frequencies of the respective ranges. In the particular spectrum 200 shown, the representative frequencies are related to each other such that f0<f1<f2.1<f2.2<f2.3<f3<f4, e.g., frequency f0 is lower than frequency f1, which is lower than frequency f2, etc. Note while the upper and lower frequency boundaries of each frequency range shown in FIG. 2 are such that the frequency ranges do not overlap with each other, it will be appreciated that techniques of the present disclosure may readily be applied to systems wherein one or more frequency ranges do overlap with each other. Furthermore, the dimensions of the frequency ranges shown in FIG. 2 are not necessarily drawn to scale, and are not meant to suggest any particular bandwidth of a frequency range relative to another.

In certain exemplary embodiments, R2.1, R2.2, R2.3 may also be denoted as “sub-ranges” of a generalized frequency range R2 (not labeled in FIG. 2). R2 may also be denoted hereinbelow as a “mid-frequency range.” As used herein, it will be appreciated that the designation of “sub-ranges” will generally denote some sub-portion of a “frequency range” along the frequency dimension. In some cases (not shown in FIG. 2), the term “sub-ranges” may further denote that the separation between two adjacent sub-ranges is less than, e.g., the separation between two adjacent ranges. However, in other cases as used herein, the designation of such “sub-ranges” need not limit their respective frequency separations in this manner, unless otherwise explicitly stated. For example, in certain cases, as will be clear from the context, the term “sub-range” and the term “range” may be used interchangeably to refer to any contiguous frequency block, wideband or narrowband.

In an exemplary embodiment, R1 may correspond to, e.g., a 699-960 MHz range (or “low range”). R2.1 may correspond to, e.g., a 1427-1511 MHz range (or “mid range”). R2.2 may correspond to, e.g., a 1559-1607 MHz range (or “GPS range”). R3 may correspond to, e.g., a 1710-2200 MHz range (or “high range”). R4 may correspond to, e.g., a 2300-2690 MHz range (or a “super high range”). Note these correspondences are described for illustrative purposes only, and are not meant to limit the scope of the present disclosure to any particular frequency ranges.

To support simultaneous processing on two or more of the ranges R0-R4, one antenna for each frequency range may be provided in a wireless device, and each antenna may be coupled to a corresponding circuitry block for processing that frequency range. While providing one antenna and/or circuitry block for one frequency range may be a straightforward design option, it is desirable to reduce the form factor of a wireless device by reducing the area occupied by the antennas. Accordingly, it would be desirable to share one or more antennas amongst the multiple frequency ranges.

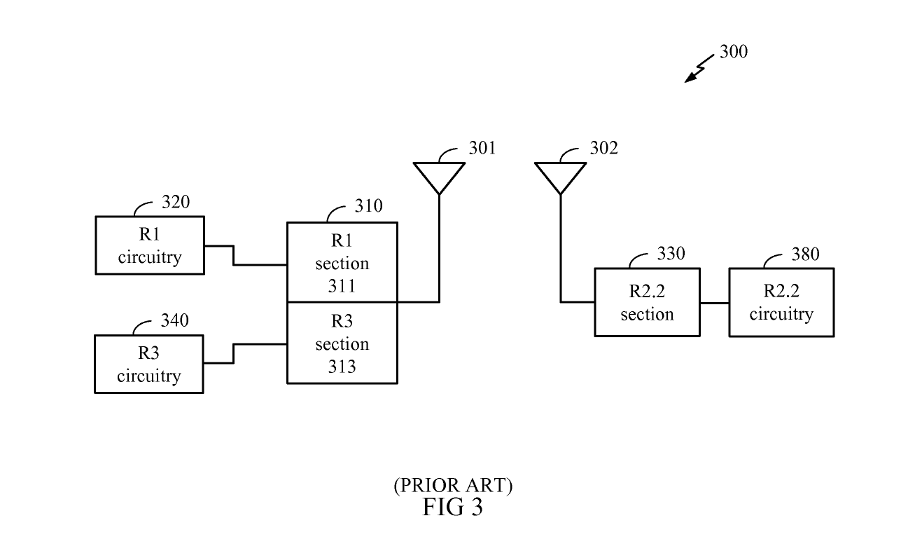

FIG. 3 illustrates a prior art implementation 300 of an RF front end in which two antennas are shared amongst circuitry for processing multiple frequency ranges. In FIG. 3, RF front end 300 includes a first antenna 301 coupled to a diplexer 310, which accommodates two frequency ranges R1, R3 using range-selective sections 311, 313, respectively. Each range-selective section of diplexer 310 may, e.g., pass through signals within the pass-band of such range-selective section, while rejecting signals outside such pass-band. Accordingly, in the receive direction, the diplexer 310 may be understood to separate (e.g., de-multiplex) signals received from first antenna 301 depending on the frequency range, and output the de-multiplexed signals to output nodes of the appropriate range-selective section 311 or 313. Similarly, in the transmit direction, the diplexer 310 may be understood to combine (e.g., multiplex) signals received from range-specific circuitry (further described hereinbelow) into one signal for transmission over first antenna 301.

As shown in FIG. 3, each of range-selective sections 311, 313 is coupled to respective range-specific circuitry 320, 340 for processing range-specific signals. Each instance of range-specific circuitry may include, e.g., further elements for processing distinct frequency channels lying within each associated frequency range. For example, R1 circuitry 320 may include a plurality of switches (not shown) that may selectively couple a received R1 signal from R1 section 311 to channel-specific RX processing circuitry (not shown). Such plurality of switches may further selectively couple channel-specific TX processing circuitry (not shown) to R1 section 311 for transmission over first antenna 301. It will be appreciated that range-specific circuitry 340 may perform similar functions as described hereinabove with reference to range-specific circuitry 320. Note that any of the terms “channel,” “band,” “carrier,” etc., as used herein may denote a particular sub-division of a frequency range, e.g., along any of the dimensions of frequency, time, code, space, etc.

In an implementation, during typical operation of RF front end 300, one channel for each of frequency ranges R1 and R3 may be selected for receive processing. Accordingly, simultaneous processing of up to two channels, e.g., one channel or “carrier” for each frequency range, may be supported according to the scheme described hereinabove, e.g., to implement a carrier aggregation (CA) feature of the LTE standard.

In an implementation, channels corresponding to R1 may include, e.g., B28A, B28B, B26, B8, while channels corresponding to R3 may include, e.g., B1, B3, B34, B39, etc., such channel designations being clear to one of ordinary skill in the art of wireless communications systems design. In an implementation, channels corresponding to R2.1 may include, e.g., EU L-Band, B11, B21, etc., and channels corresponding to R4 may include, e.g., B7, B40, B41, etc.

RF front end 300 further includes a second antenna 302 coupled to an R2.2 range-selective section 330. In an implementation, range-selective section 330 is configured to pass through signals within the R2.2 frequency range, while rejecting signals outside R2.2. R2.2 section 330 is further coupled to R2.2 range-specific circuitry 380 for processing R2.2 signals. In a scenario wherein R1 corresponds to the low range, R2.2 corresponds to the GPS range, and R3 corresponds to the high range, the RF front end 300 provides one implementation for accommodating, e.g., dual carrier aggregation on R1 and R3 using first antenna 301, while simultaneously processing a GPS signal using second antenna 302.

In certain state-of-the-art applications, it would be desirable for RF front end 300 to process additional frequency ranges not shown in FIG. 3. For example, certain carrier aggregation applications may require three or more carriers to be simultaneously processed, e.g., carriers on R2.1, R2.3, and/or R4, in addition to the ranges R1, R3, R2.2 illustratively shown in FIG. 3. In an implementation, diplexer 310 in RF front end 300 may be replaced by a quadplexer (e.g., for accommodating four separate frequency ranges) to effectively deal with such additional carriers. However, designing a single antenna 301 and/or quadplexer (not shown in FIG. 3) to simultaneously accommodate three or more frequency ranges may require a very broadband response for the passive elements, which may undesirably decrease the receive signal path's overall gain as well as increase the physical dimensions of the overall device.

It would thus be desirable to provide novel and effective techniques for efficiently processing a plurality of frequency ranges in a single wireless device.

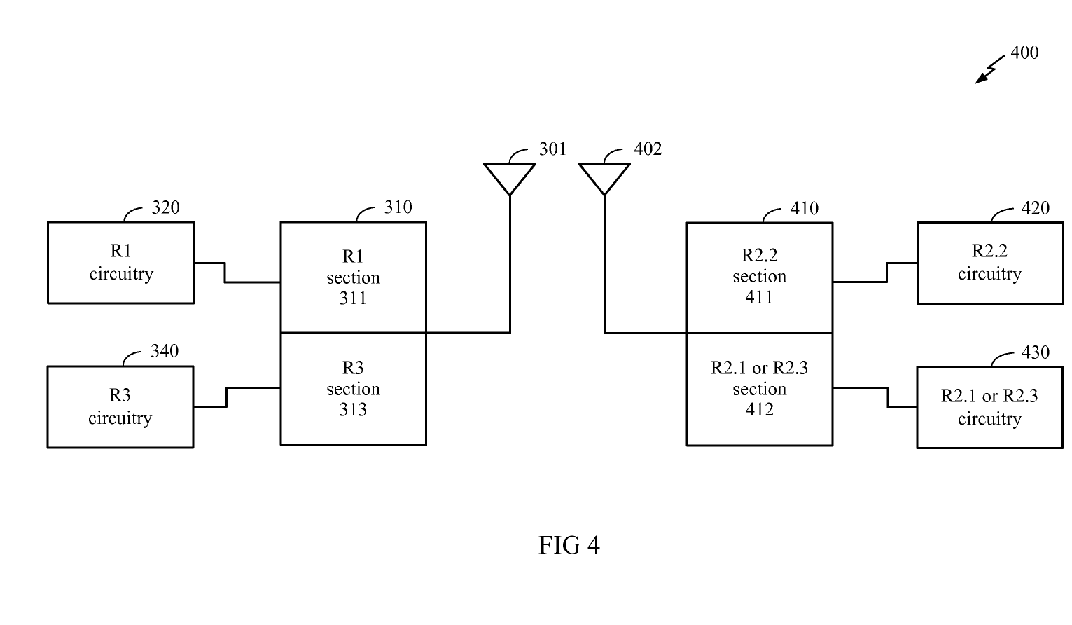

FIG. 4 illustrates an exemplary embodiment 400 of an RF front end for simultaneously processing multiple frequency ranges according to the present disclosure. Note FIG. 4 is shown for illustrative purposes only, and is not meant to limit the scope of the present disclosure to any particular exemplary embodiment shown. Further note that similarly labeled elements in FIGS. 3 and 4, and generally throughout the figures, may correspond to elements performing similar functionality, unless otherwise noted, and accordingly, description of such similarly labeled elements may be omitted for simplicity.

In FIG. 4, RF front end 400 includes a second antenna 402 coupled to a frequency separation block 410. Block 410 is designed to accommodate two frequency sub-ranges: 1) R2.2 using range-selective section 411, and 2) R2.1 or R2.3 using range-selective section 412. Each range-selective section of block 410 may, e.g., pass through signals within the pass-band of such range-selective section, while rejecting signals outside of such pass-band. Accordingly, in the receive direction, block 410 may be understood to separate (e.g., de-multiplex) signals received from second antenna 402 depending on the frequency sub-range, and output the de-multiplexed signal to an output node of the appropriate range-selective section 411 or 412. Similarly, in the transmit direction, block 410 may be understood to combine (e.g., multiplex) signals received from range-specific circuitry (further described hereinbelow) into one signal for transmission over second antenna 402.

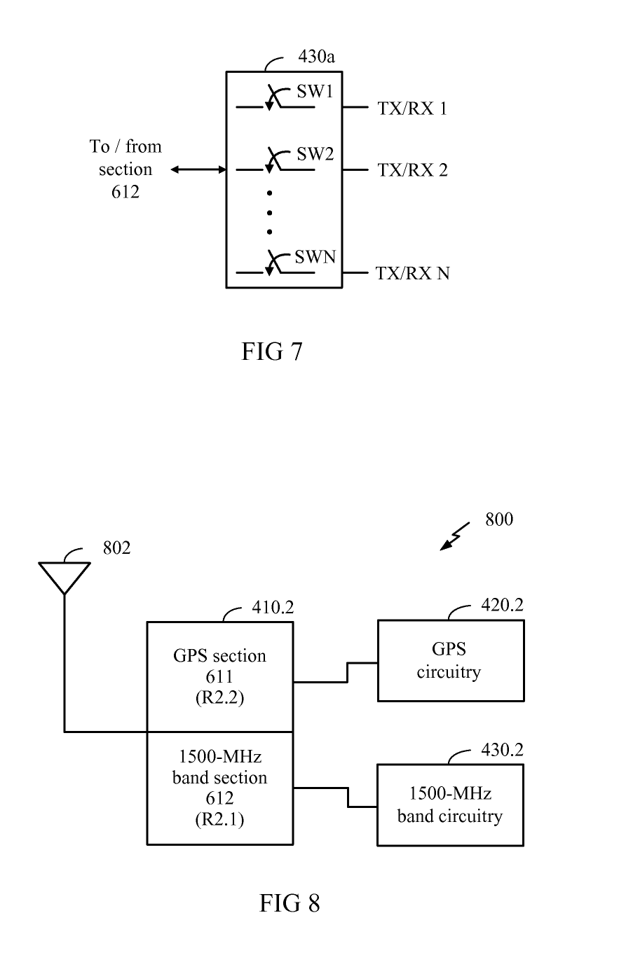

As shown in FIG. 4, each of range-selective sections 411, 412 is coupled to respective range-specific circuitry 420, 430 for processing range-specific signals. Each instance of range-specific circuitry may include, e.g., further elements for processing distinct frequency channels lying within each associated frequency range. For example, R2.2 circuitry 420 may selectively couple a received R2.2 signal from R2.2 section 411 to channel-specific RX processing circuitry (not shown). Range-specific circuitry 430 may include a plurality of switches (not shown) that may selectively couple R2.1 or R2.3 signals from section 412 to further channel-specific processing circuitry (not shown), e.g., as further described hereinbelow with reference to FIG. 7.

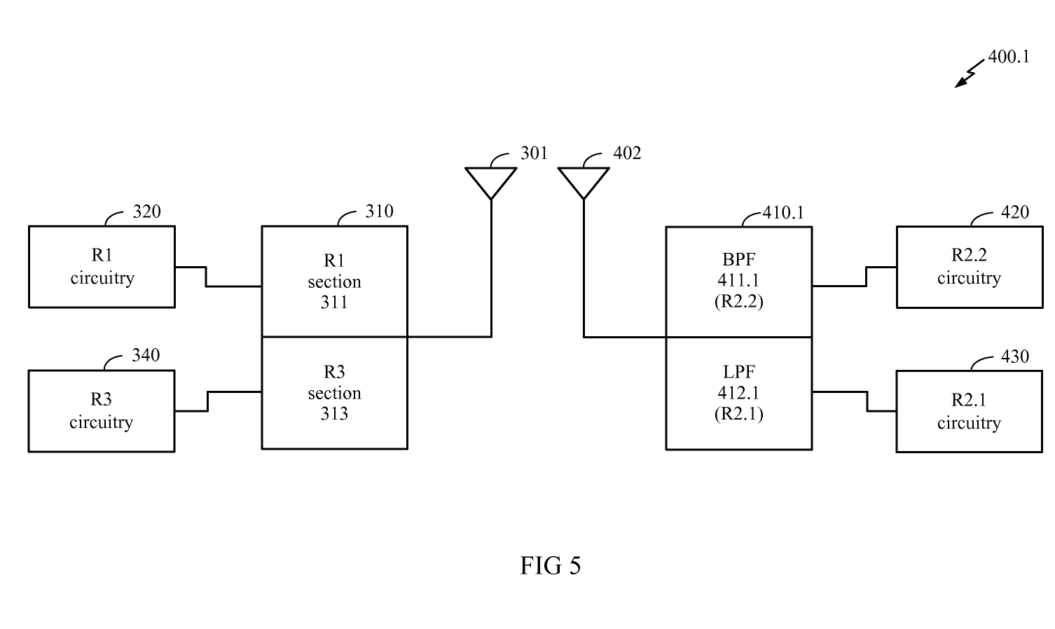

In an exemplary embodiment, block 410 may correspond to a diplexer, e.g., a diplexer similar to diplexer 310 used to separate frequency ranges R1 and R3. In alternative exemplary embodiments, block 410 need not correspond to a “diplexer” as such term is used in the art, but may correspond to any block designed to separate one range of frequencies from another, e.g., as further described hereinbelow with reference to FIG. 5.

In an exemplary embodiment, range-selective section 412 processes R2.1 (rather than R2.3), and the frequency separation between ranges R2.1 and R2.2 (also denoted “sub-ranges” in this exemplary embodiment) is relatively narrow compared to the frequency separation between R1 and R3. For example, in this exemplary embodiment, R1 may correspond to 699-960 MHz, R2.1 may correspond to 1427-1511 MHz, R2.2 may correspond to 1559-1607 MHz, and R3 may correspond to 1710-2200 MHz. In this example, the upper frequency of R1 is separated from the lower frequency of R3 by 599 MHz, while the upper frequency of R2.1 is separated from the lower frequency of R2.2 by only 48 MHz. Given such specifications, it will be appreciated that the selectivity requirements of elements in frequency separation block 410, e.g., as quantified by filter quality (Q) factors, will be more stringent than those of elements in, e.g., diplexer 310, or a “duplexer” for separating transmit from receive signals, as such term is used in the art.

FIG. 5 illustrates an exemplary embodiment 400.1 including a frequency separation block 410.1 having an R2.1 section 412.1 and an R2.2 section 411.1. In particular, R2.1 section 412.1 has low-pass filter (LPF) characteristics, e.g., with an upper cut-off frequency associated with the upper frequency of R2.1. R2.2 section 411.1 has band-pass filter (BPF) characteristics, e.g., with lower and upper cut-off frequencies associated with the lower and upper frequency limits, respectively, of R2.2. In an exemplary embodiment wherein the upper frequency of R2.1 is close to the lower frequency of R2.2 (e.g., relative to the bandwidth of the LPF or BPF), it will be appreciated that the Q factor associated with the LPF and/or BPF should be made sufficiently high to achieve the requisite isolation.

Note the exemplary embodiments of R2.1 section 412.1 and R2.2 section 411.1 as an LPF and a BPF, respectively, are not meant to limit the scope of the present disclosure, and the frequency selective sections may be alternatively designed. In alternative exemplary embodiments (not shown), section 412.1 may be implemented as a band-pass filter, and/or section 411.1 may be implemented as a high-pass filter. In yet alternative exemplary embodiments wherein section 412 accommodates R2.3 instead of R2.1, section 411 may be implemented as a band-pass filter, and/or section 412 may alternatively be implemented as a high-pass filter. Such alternative exemplary embodiments are contemplated to be within the scope of the present disclosure.

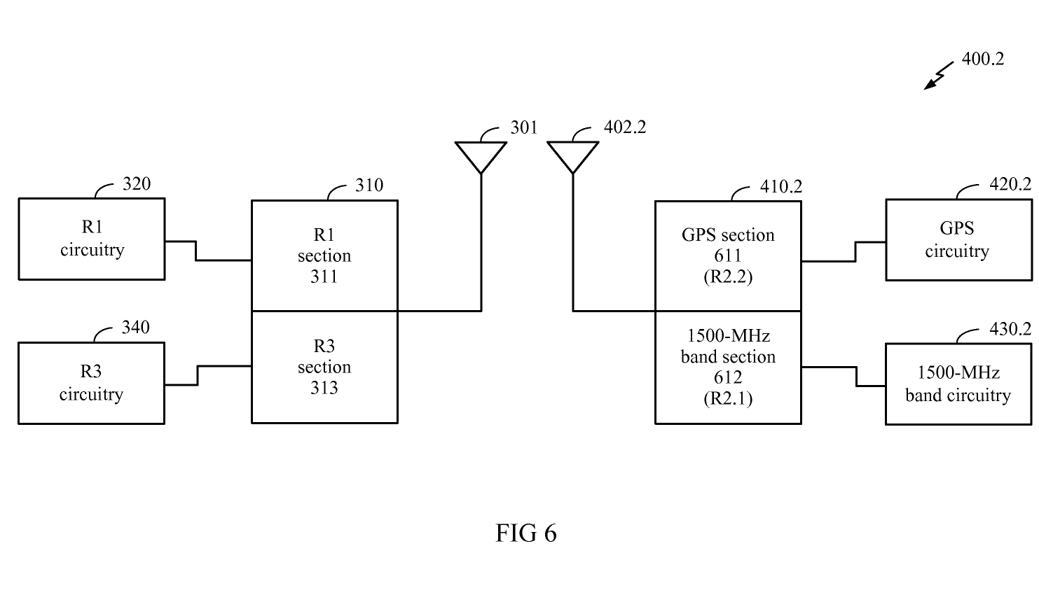

FIG. 6 illustrates an exemplary embodiment 400.2 of an RF front end according to the present disclosure. Note the exemplary embodiment 400.2 is shown for illustrative purposes only, and is not meant to limit the scope of the present disclosure to any particular frequency ranges described.

In FIG. 6, frequency separation block 410.2 includes a GPS section 611 (R2.2) and a 1500-MHz band section 612 (R2.1). As described hereinabove, GPS section 611 may be implemented using a band-pass filter tuned to the GPS frequency range, while 1500-MHz band section 612 may be implemented using a low-pass filter. In FIG. 6 wherein R2.2 corresponds to a GPS frequency range, then GPS section 611 having BPF characteristics may also be referred to herein as a “GPS extractor filter.”

It will be appreciated that configuring the frequency processing sections as shown in FIG. 6 advantageously allows RF front end 400.2 to accommodate four frequency ranges, i.e., R1, R3, GPS (R2.2), and a 1500-MHz band (R2.1) adjacent the GPS range, without incorporating a lossy and expensive quadplexer.

FIG. 7 illustrates an exemplary embodiment 430a of range-specific circuitry 430, e.g., provided for R2.1 in FIG. 5. Note FIG. 7 is shown for illustrative purposes only, and is not meant to limit the scope of the present disclosure. In FIG. 7, range-specific circuitry 430a corresponds to a switch module having a plurality of switches SW1 through SWN. In an exemplary embodiment, each of the switches may be associated with a channel, such as a sub-division of a frequency range along any dimension, e.g., frequency, time, space, etc. Each switch selectively couples a signal to/from the corresponding range-selective section (e.g., 612) with channel-specific processing circuitry TX/RX 1 through TX/RX N.

In an implementation, during typical operation of RF front end 400, one switch in circuitry 430a may be closed, and the other switches associated with channels not being actively processed may be opened. In this manner, a unique transceiver block may effectively be selected to actively process a channel of each frequency range. Note while each instance of channel-specific circuitry in FIG. 7 is indicated as being coupled to transmitting and receiving functions, it will be appreciated that the scope of the present disclosure is not restricted to channel-specific circuitry having both transmit and receive functionality. In certain exemplary embodiments, circuitry accommodating either transmit or receive functionality for a single channel may also be included. Such alternative exemplary embodiments are contemplated to be within the scope of the present disclosure.

Note the techniques described hereinabove are not meant to limit the scope of the present disclosure to RF front ends necessarily incorporating more than one antenna. FIG. 8 illustrates an exemplary embodiment wherein one antenna with associated range-specific circuitry is provided in a wireless device. Note FIG. 8 is shown for illustrative purposes only. In FIG. 8, RF front end 800 includes an antenna 802 coupled to a range selection block 410.2 for processing a GPS range using section 611 and a 1500-MHz band using section 612, further coupled to range-specific circuitry 420.2 and 430.2, respectively. In the exemplary embodiment shown, elements of RF front end 800 are provided independently of elements for processing other frequency ranges not shown in FIG. 8 (e.g., R1, R3, etc.). Such exemplary embodiments are contemplated to be within the scope of the present disclosure.

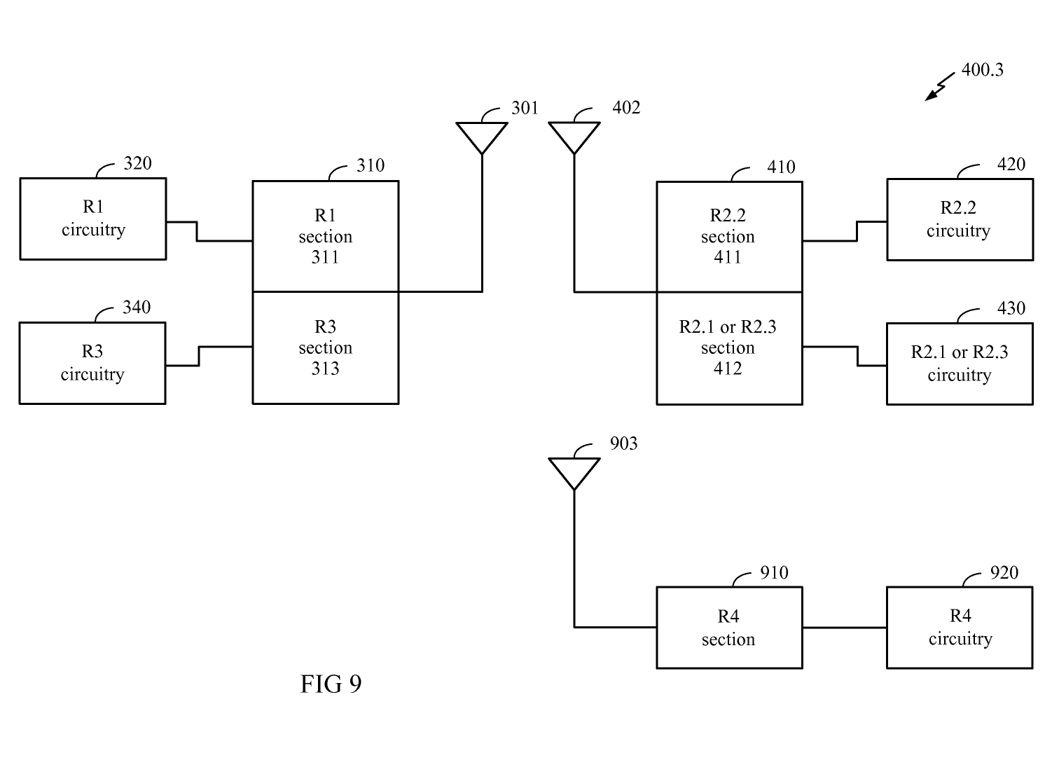

FIG. 9 illustrates an alternative exemplary embodiment 400.3 of RF front end 400 accommodating three antennas according to the present disclosure. Note similarly labeled elements in FIGS. 4 and 9 may correspond to elements performing similar functionality, unless otherwise mentioned. In FIG. 9, RF front end 400.3 includes a third antenna 903 configured to receive and transmit signals on a frequency range R4. Third antenna 903 is coupled to a frequency separation block 910 configured to cover R4. In an exemplary embodiment, block 910 may correspond to, e.g., a band-pass filter. Block 910 is further coupled to R4 circuitry 920 for processing of, e.g., channel-specific signals in R4.

From FIG. 2, it will be noted that R4 is higher than the other frequency ranges shown in FIG. 9 (i.e., f4>f3>f2.2>f2.1>f1). As the physical dimensions of an antenna are generally inversely proportional to the lowest frequency (or directly proportional to the longest wavelength) the antenna needs to support, the size of antenna 903 is expected to be smaller than the sizes of antennas 301 and 402 in RF front end 400.3. Accordingly, it will be appreciated that providing a third antenna 903 in addition to antennas 301 and 402 is generally not expected to consume a significant amount of additional space relative to, e.g., providing only antennas 301 and 402. In this manner, RF front end 400.3 affords a generally area-efficient architecture for simultaneously accommodating up to five frequency ranges in a wireless device.

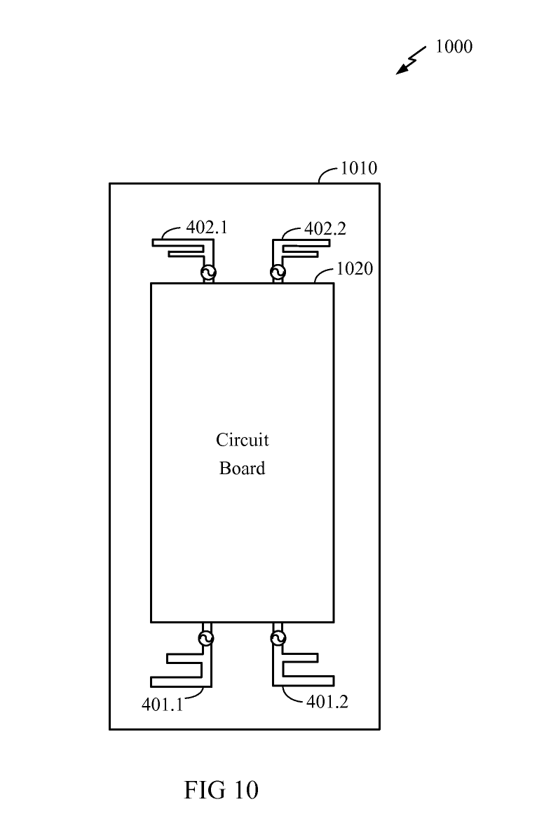

FIG. 10 illustrates an exemplary embodiment 1000 of a wireless device implementing the techniques of the present disclosure. Note FIG. 10 is shown for illustrative purposes only, and is not meant to limit the scope of the present disclosure. For example, alternative exemplary embodiments may accommodate less or more than the exemplary number of antennas shown. Such alternative exemplary embodiments are contemplated to be within the scope of the present disclosure.

In FIG. 10, wireless device 1000 includes a body 1010, on which is provided a circuit board 1020. The circuit board 1020 includes circuitry (not shown) for transmitting and receiving signals from a plurality of antennas 401.1, 401.2, 402.1, 402.2. In the exemplary embodiment shown, antennas 401.1 and 401.2 may each correspond to antenna 301 in FIG. 4, e.g., accommodating R1 and R3, with respective circuitry coupled thereto (not shown in FIG. 10). Furthermore, antennas 402.1 and 402.2 may each correspond to the antenna 402 in FIG. 4, e.g., accommodating R2.2 and R2.1 or R2.3, with respective circuitry coupled thereto (not shown in FIG. 10), as described hereinabove.

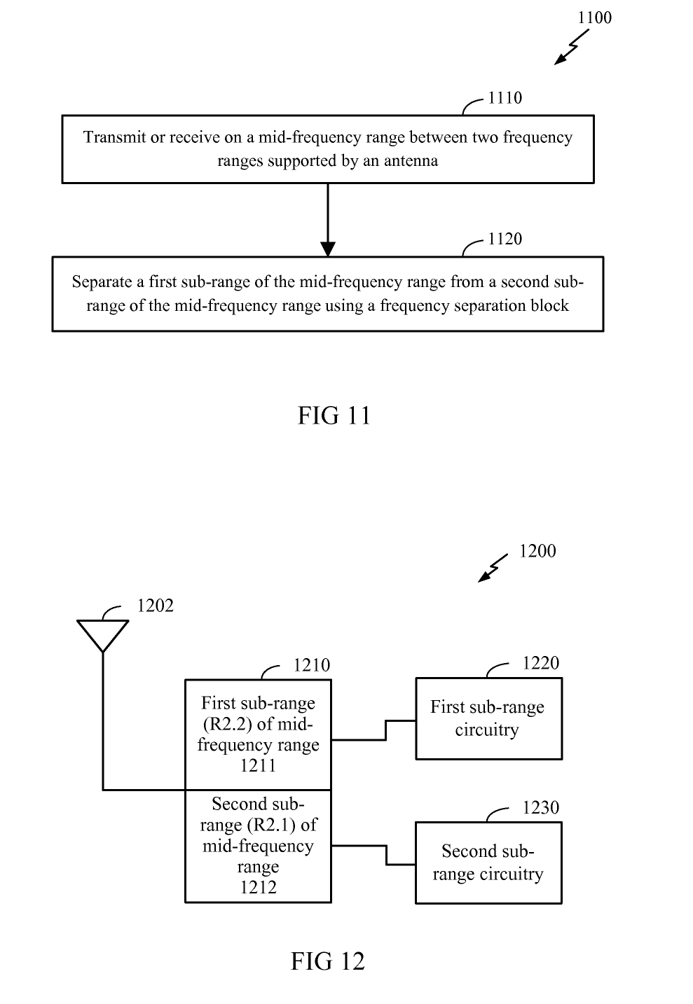

FIG. 11 illustrates an exemplary embodiment of a method 1100 according to the present disclosure. Note FIG. 11 is shown for illustrative purposes only, and is not meant to limit the scope of the present disclosure to any particular method shown.

In FIG. 11, at block 1110, the method includes transmitting or receiving on a mid-frequency range between two frequency ranges supported by an antenna.

At block 1120, the method includes separating a first sub-range of the mid-frequency range from a second sub-range of the mid-frequency range using a frequency separation block.

FIG. 12 illustrates an alternative exemplary embodiment wherein one antenna with associated range-specific circuitry is provided in a wireless device. Note FIG. 12 is shown for illustrative purposes only. In FIG. 12, RF front end 1200 includes a first antenna 1202 configured to transmit or receive on a mid-frequency range (e.g., R2). The mid-frequency range may lie between two frequency ranges supported by another antenna (not shown in FIG. 12), e.g., R1 and R3. A frequency separation block 1210 is coupled to the first antenna 1202, and includes a first frequency-selective section 1211 and a second frequency-selective section 1212. The frequency separation block is configured to separate a first sub-range (e.g., R2.2) of the mid-frequency range from a second sub-range (e.g., R2.1) of the mid-frequency range. Sections 1211 and 1212 are further coupled to first sub-range circuitry 1220 and second sub-range circuitry 1230, respectively.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present. Furthermore, when an element is referred to as being “electrically coupled” to another element, it denotes that a path of low resistance is present between such elements, while when an element is referred to as being simply “coupled” to another element, there may or may not be a path of low resistance between such elements.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the exemplary aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary aspects of the invention.

The various illustrative logical blocks, modules, and circuits described in connection with the exemplary aspects disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the exemplary aspects disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-Ray disc where disks usually reproduce data magnetically, while discs reproduce data optically with lasers. Combinations of the above should also be included within the scope of computer-readable media.

The previous description of the disclosed exemplary aspects is provided to enable any person skilled in the art to make or use the invention. Various modifications to these exemplary aspects will be readily apparent to those skilled in the art, and the generic principles defined herein may be applied to other exemplary aspects without departing from the spirit or scope of the invention. Thus, the present disclosure is not intended to be limited to the exemplary aspects shown herein but is to be accorded the widest scope consistent with the principles and novel features disclosed herein.

1. An apparatus comprising:
a first antenna configured to transmit or receive on a mid-frequency range between two frequency ranges supported by another antenna; and
a frequency separation block coupled to the first antenna, the frequency separation block comprising a first frequency-selective section and a second frequency-selective section, wherein the frequency separation block is configured to separate a first sub-range of the mid-frequency range from a second sub-range of the mid-frequency range.

2. The apparatus of claim 1, the first sub-range of the mid-frequency range including a signal having frequency between 1559 MHz and 1607 MHz, and the second sub-range of the mid-frequency range including a signal having frequency between 1427 MHz and 1511 MHz.

3. The apparatus of claim 2, further comprising first circuitry for processing a global positioning system (GPS) signal, the first circuitry coupled to the first frequency-selective section.

4. The apparatus of claim 3, further comprising second circuitry for processing a cellular telephony signal, the second circuitry coupled to the second frequency-selective section.

5. The apparatus of claim 4, the second circuitry comprising a plurality of switches for selectively coupling a signal in the second sub-range of the mid-frequency range to channel-specific circuitry.

6. The apparatus of claim 5, wherein the channel-specific circuitry comprises transceiver circuitry.

7. The apparatus of claim 1, further comprising:
a second antenna configured to transmit or receive on said two frequency ranges; and
a third antenna configured to transmit or receive on a fourth frequency range higher than said two frequency ranges.

8. The apparatus of claim 7, further comprising circuitry coupled to the second antenna and the second frequency-selective section, the circuitry configured to simultaneously process at least two carriers received on at least two of said two frequency ranges, fourth frequency range, and the second sub-range of the mid-frequency range.

9. The apparatus of claim 8, the circuitry configured to process said at least two simultaneous carriers according to a carrier aggregation specification of the Long Term Evolution (LTE) standard.

10. The apparatus of claim 1, further comprising a first auxiliary antenna and a second auxiliary antenna, the first and second auxiliary antennas having the same specifications as the first and second antennas, respectively, to afford spatial diversity for the apparatus.

11. An apparatus comprising:
means for transmitting or receiving on a mid-frequency range between two frequency ranges supported by an antenna; and
means for separating a first sub-range of the mid-frequency range from a second sub-range of the mid-frequency range.

12. The apparatus of claim 11, the first sub-range of the mid-frequency range including a signal having frequency between 1559 MHz and 1607 MHz, and the second sub-range of the mid-frequency range including a signal having frequency between 1427 MHz and 1511 MHz.

13. The apparatus of claim 12, further comprising:
means for processing a global positioning system (GPS) signal received from the first sub-range of the mid-frequency range.

14. The apparatus of claim 11, further comprising means for selectively coupling a signal in the second sub-range of the mid-frequency range to channel-specific circuitry.

15. The apparatus of claim 11, further comprising means for simultaneously processing at least two carriers received on at least two of said two frequency ranges and the second sub-range of the mid-frequency range.

16. A method comprising:
transmitting or receiving on a mid-frequency range between two frequency ranges supported by an antenna; and
separating a first sub-range of the mid-frequency range from a second sub-range of the mid-frequency range using a frequency separation block.

17. The method of claim 16, the first sub-range of the mid-frequency range including a signal having frequency between 1559 MHz and 1607 MHz, and the second sub-range of the mid-frequency range including a signal having frequency between 1427 MHz and 1511 MHz.

18. The method of claim 17, further comprising:
processing a global positioning system (GPS) signal received from the first sub-range of the mid-frequency range.

19. The method of claim 16, further comprising selectively coupling a signal in the second sub-range of the mid-frequency range to channel-specific circuitry.

20. The method of claim 16, further comprising simultaneously processing at least two carriers received on at least two of said two frequency ranges and the second sub-range of the mid-frequency range.
